(19) United States
(12) Patent Application Publication
(10) Pub. No.: US 2017/0270149 A1
(43) Pub. Date: Sep. 21, 2017

(54) DATABASE SYSTEMS WITH RE-ORDERED REPLICAS AND METHODS OF ACCESSING AND BACKING UP DATABASES

(71) Applicant: HUAWEI TECHNOLOGIES CO., LTD., Shenzhen (CN)

(72) Inventors: Robin GROSMAN, Markham (CA); Danny CHEN, Aurora (CA)

(21) Appl. No.: 15/070,861

(22) Filed: Mar. 15, 2016

(51) Int. Cl. G06F 17/30

(52) U.S. Cl. CPC G06F 17/30368; G06F 17/30578; G06F 17/30321; G06F 17/30589; G06F 17/30424

(57) ABSTRACT

A database system comprises: a data store containing a database comprising records ordered according to a first key field, and a search index of the first key field. The database system also comprises a replica data store, containing a replica copy of the database, with the records ordered according a second key field, different from the first key field, and a search index of the second key field. A server is configured to receive a request to access the records, and to access the records using the replica copy if the request includes a criterion based on values of the second key field.

### FIELD

This relates to databases, and in particular to replication systems and methods for databases.

### BACKGROUND

In large databases, indexing data can speed up data access and filtering operations. Traditionally, databases may be indexed using search trees. Using search trees, queries or other data access requests can be performed by searching the tree, which, points to the relevant records that satisfy certain selection criteria, rather than by evaluating each record individually against the criteria.

Many types of search trees exist that can be used for indexing database contents. For example, some indexes may be binary search trees. Other indexes may be B-tree indexes. Such indexes can provide for fast access. Index performance may be greatest when database contents are ordered according to the indexed field or column, that is, when database records are stored in order of values of the indexed field.

Unfortunately, search indexes require extra storage space. In addition, certain database operations, particularly insertions, deletions and data updates, may necessitate updating of the index, and therefore, may be relatively slow.

Moreover, in many databases, data may need to be searched based on any of a plurality of fields. In such situations, space requirements for storing search index data may be particularly high. Likewise, data insertion and deletion may be particularly slow. Moreover, database contents may be such that some fields or columns cannot be indexed. For example, if data is ordered on a first column, values in a second column may be randomly distributed and not suitable for indexing.

Modern database systems typically employ replication to maintain multiple copies of data in order to ensure availability even in the event of component failure. For example, many database systems store 2-3 copies of data. Copies may be exact replicas of one another, or copies with erasure encoding, such as in certain types of RAID (redundant array of inexpensive disks) storage. Generally, index data, such as B-tree index data is backed up along with database contents, to ensure accessibility of data and limit performance degradation in the event of a component failure.

### SUMMARY

Disclosed herein is a database system comprising: a first server; a first data store at the first server containing a primary copy of a database comprising records, including at least first and second key fields, the records stored in a first order; a replica data store, containing a replica copy of the database, with the records stored in a second order different from the first order, according to values of the second key field, different from the first key field; the first server configured to receive a request to access the records, and access said records from the replica copy if the request includes a criterion based on values of the second key field.

Also disclosed herein is a method of backing up database records ordered in a first order, comprising: selecting a key field; copying the database records to a data store to create a replica copy; and ordering the database records of the replica copy in a second order, different from the first order and according to values of the key field.

Also disclosed herein is a method of accessing database records on a database system comprising a primary database copy and at least one replica database copy, records of the replica copy ordered differently than records of the primary copy and based on a database field. The method comprises: receiving a request to access said database records, said request comprising a selection criterion based on a value of a queried database field; selecting one of said primary copy and said replica copy, said selected one of said primary copy and said replica copy ordered based on said queried database field; and returning database records by searching an index of said queried database field at the selected one of said primary copy and said replica copy.

Other aspects of the present disclosure will be apparent from the detailed description and figures.

### BRIEF DESCRIPTION OF DRAWINGS

In the figures, which illustrate example embodiments:

FIG. 1 is a block diagram of a database system and client computing device;

FIG. 2 is a block diagram of a server of the database system of FIG. 1;

FIG. 3 is a diagram of software at the server of FIG. 2;

FIG. 4 is a diagram of components of the software of FIG. 3;

FIG. 5 is a schematic diagram of a database table of the database system of FIG. 1;

FIG. 6 is a schematic diagram of a workload log of the database system of FIG. 1;

FIGS. 7A-7B are schematic diagrams of indexes of the database table of FIG. 5;

FIGS. 8A and 8B are schematic diagrams of replicas of the database system of FIG. 1;

FIG. 9 is a flow diagram of a process of creating a replica;

FIG. 10 is a flow diagram of a process of handling an access request;

FIG. 11 is a flow diagram of a process of updating data in a database; and

FIG. 12 is a flow diagram of a process of updating a replica.

### DETAILED DESCRIPTION

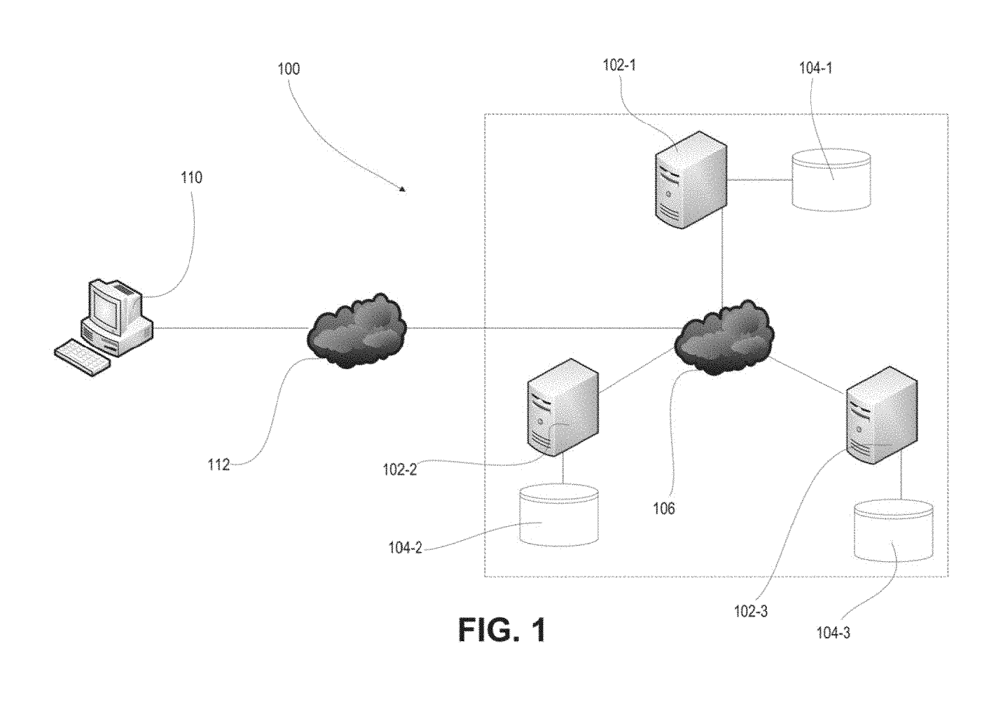

FIG. 1 depicts an example database system 100. Database system 100 includes a plurality of servers 102, each with interconnected data storage 104. Servers 102 may be interconnected via a network 106, which may be an IPv4, IPv6, X.25, IPX compliant or similar network, including one or more wired or wireless access points. Network 106 may be a local-area network (LAN) or a wide-area network (WAN), such as the internet, and may be connected with other communications networks, such as GSM/GPRS/3G/4G/LTE networks. Each server 102 may host a database data in its interconnected data storage 104. As depicted, database system 100 includes 3 servers 102-1, 102-2, 102-3 (individually and collectively, servers 102), each with a respective data storage 104-1, 104-2, 104-3 (individually and collectively, data storage 104). However, in other embodiments, more or fewer servers 102 and data storage 104 may be present.

Servers 102-1, 102-2, 102-3 may be physically separate machines, which may be located remotely from one another. Alternatively, servers 102-1, 102-2, 102-3 may be separate server instances running on a single machine. For example, servers 102-1, 102-2, 102-3 may be virtual machines or may be run on separate drives or partitions.

Database system 100 may be accessible by one or more client computing devices 110. Client computing devices 110 may be connected directly to network 106, or may be connected to network 106 by way of another network 112, which may be a LAN or a WAN such as the internet. Client computing devices 110 may be, for example personal computers, smartphones, tablet computers, or the like, and may be based on any suitable operating system, such as Microsoft Windows, Apple OS X or iOS, Linux, Android, or the like.

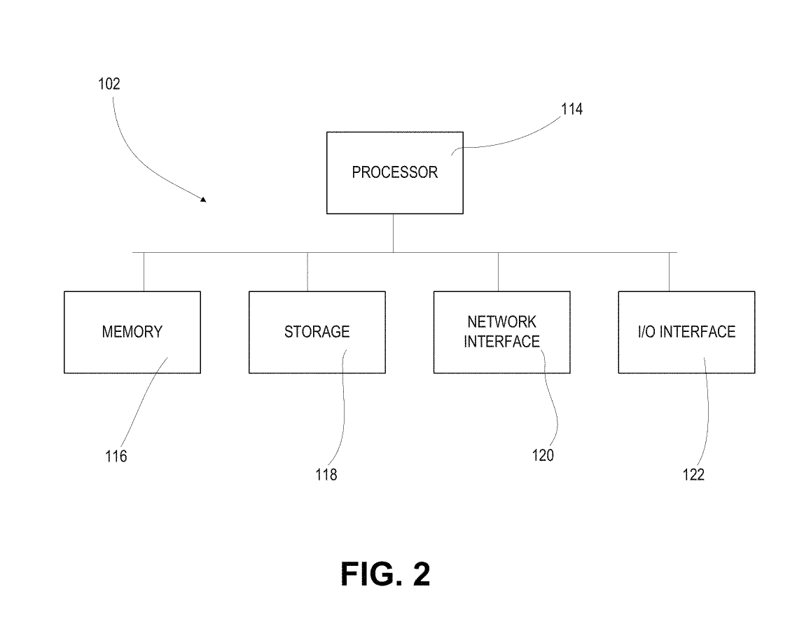

FIG. 2 is a block diagram of components of an example server 102. As depicted, each server 102 includes a processor 114, memory 116, persistent storage 118, network interface 120 and input/output interface 122.

Processor 114 may be an Intel or AMD x86 or x64, PowerPC, ARM processor, or the like. Processor 114 may operate under control of software loaded in memory 116. Network interface 120 connects server 102 to network 106. I/O interface 122 connects server 102 to storage 104 and may further connect server 102 to one or more peripherals such as keyboards, mice, USB devices, disc drives, and the like.

Software may be loaded onto server 102 from peripheral devices or from network 106. Such software may be executed using processor 114.

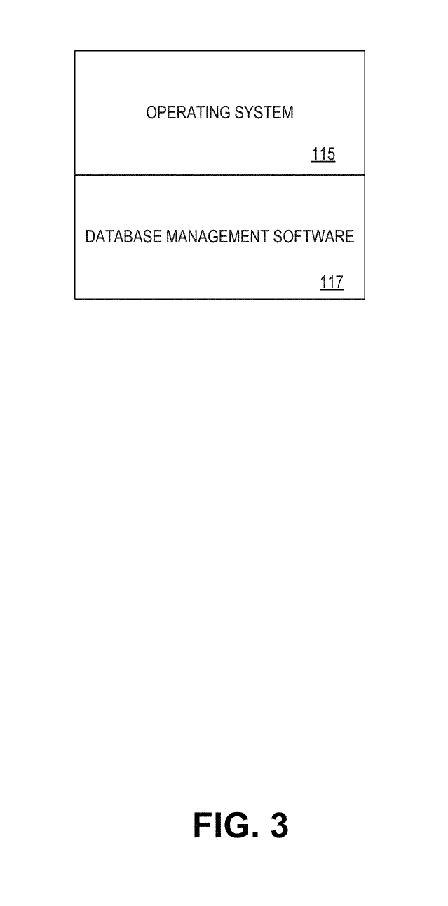

FIG. 3 depicts a simplified arrangement of software at a server 102. The software may include an operating system 116 and application software, such as database management system 117. Database management system may be a system configured for compatibility with the relational database model using a language such as SQL.

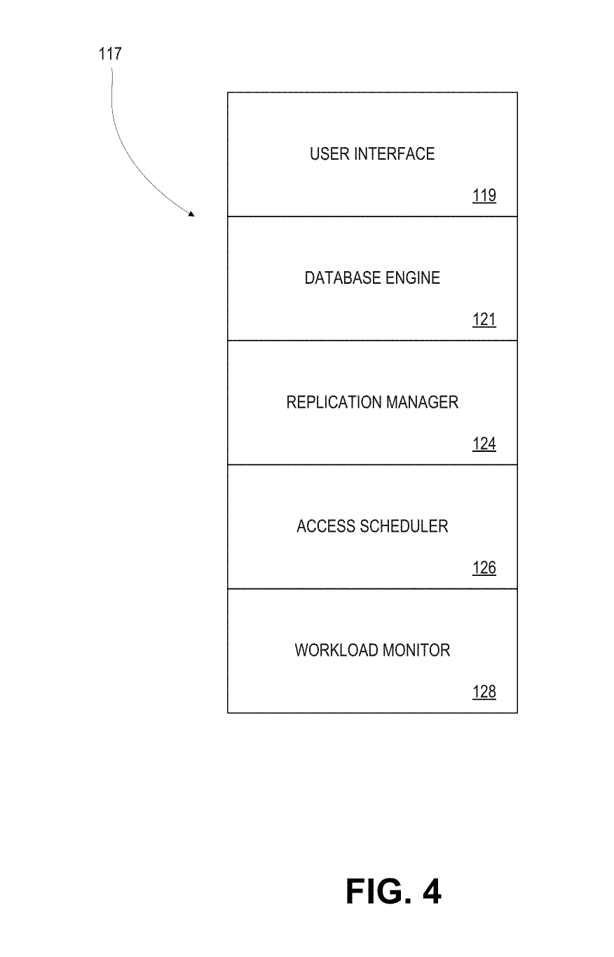

Database management system 117 may itself have a number of components, as depicted in FIG. 4. For example, database management system 117 may include a user interface 119, a database engine 121, a replication manager 124, an access scheduler 126 and a workload monitor 128. Instances of database management system at different servers 102 may communicate with one another, for example, to send and receive instructions or data.

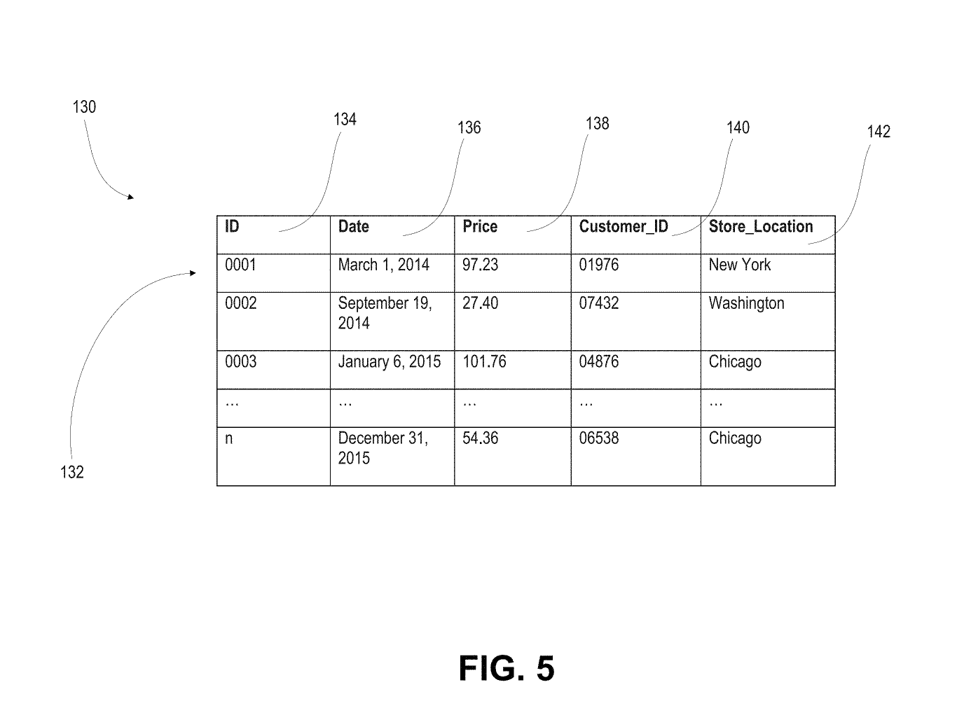

Database management system 117 may maintain a database 130 in storage 104, e.g. a relational database comprising one or more tables with fields in columnar format. FIG. 5 depicts a table representative of data in database 130. Database engine 122 may allow database management system 117 to access the database 130 for the purpose of reading, creating, deleting, updating records and the like. As used herein, references to columns or rows of database 130 may relate to columns or rows of tables within database 130. References herein to ordering or sorting based on a column mean ordering or sorting based on values of a field stored in that column. In other embodiments, database 130 may be another type of database, such as a document-oriented database or an object-oriented database. In such embodiments, database records may correspond to documents or objects, respectively. Columns may correspond to data fields in the objects or records. Rows may likewise correspond to documents or objects, such that references to ordering of rows may instead relate to ordering of documents or objects.

As depicted, database 130 includes a plurality of records 132 of sales data. Each record 132 contains values in a number of fields arranged in columns. As depicted, the values are associated with a sales transaction and may include values in an ID column 134, a date column 136, a price column 138, a customer_ID column 140 and a Store_Location column 142. However, as will be apparent, database 130 may have more or fewer columns that those depicted and may contain information other than sales information. Database 130 may optionally be stored on storage 104 such that entries in one of the columns 134, 136, 138, 140, 142 are in order or reverse order. As used herein, the “order” of storage refers to locations in a data store.

User interface 120 may be configured to receive requests for accessing data in database 130 and to return results. User interface 120 may be presented locally at server 102 for operation by a user. Alternatively, or additionally, user interface 120 may be presented remotely, e.g., through a web browser or application at a client computing device 110.

Requests entered through user interface 120 may include record insertion, deletion or update, and queries based on one or more columns. For example, a user may request all records having value “New York” in Store_Location column 142 and a value greater than or equal to 50 in Price column 138. User interface 120 may be operable to receive instructions from a user, e.g., by text entry or using a graphical menu, and convert those instructions to a database language, such as SQL. For example, a query for all records having value “New York” in Store_Location column 142 may be as follows:
SELECT*WHERE Store_Location=“New York” AND Price>=50

Access requests received by database management system 117 may be logged by workload monitor 128. In particular, workload monitor 128 may maintain a log of the number and frequency of access requests, and search criteria associated with such requests. For example, workload monitor 128 may log the number and frequency of requests which require searching on each column of database 130. Workload monitor 128 may also log the time for each access request to be completed. As used herein, the “workload” of a database refers to the set of requests for access to the database.

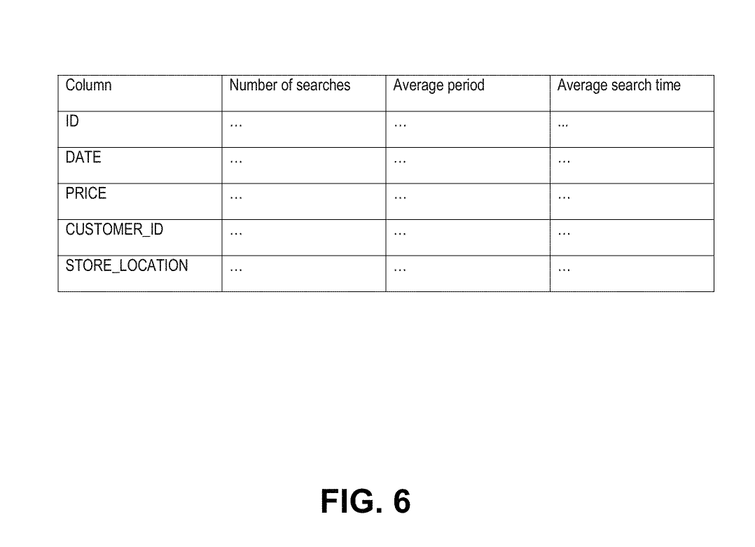

FIG. 6 depicts an example workload log 146 stored by workload monitor 128. As shown, workload monitor 128 maintains, for each column of database 130, a log of the number of requests requiring a search on the column, frequency of such requests the average period, i.e. the average time elapsed, between requests, and performance data, such as the average time to execute such requests. Workload monitor 128 may determine, based on the data in workload log 146, an estimate of the importance of each column on overall database performance. The performance impact may be a representation of the aggregate time spent searching on each column. For example, columns may be ranked based on a ratio of the average time to complete a query to the average period between queries. Other possibilities exist and will be apparent to skilled persons.

In an example, workload monitor 128 may also maintain weight scores in workload log 146. Weight scores may, for example be initialized to a certain initial value for each column, and be incremented each time an operation is performed using a particular column. Weight scores may be adjusted to account for the amount of time required to perform operations using each column. For example, weight scores may be adjusted according to a scaling value proportional to the average time to execute requests.

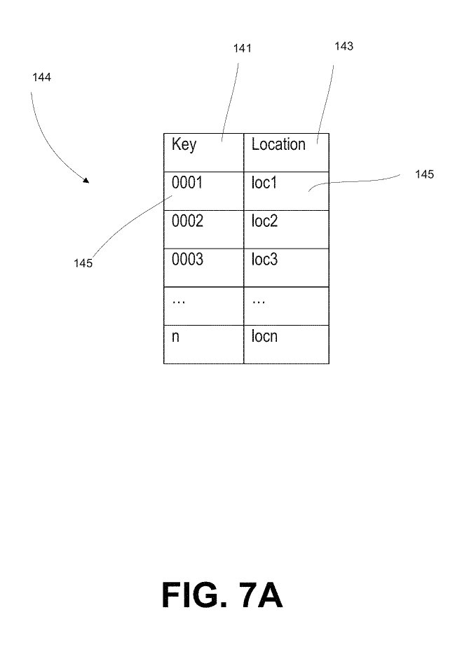

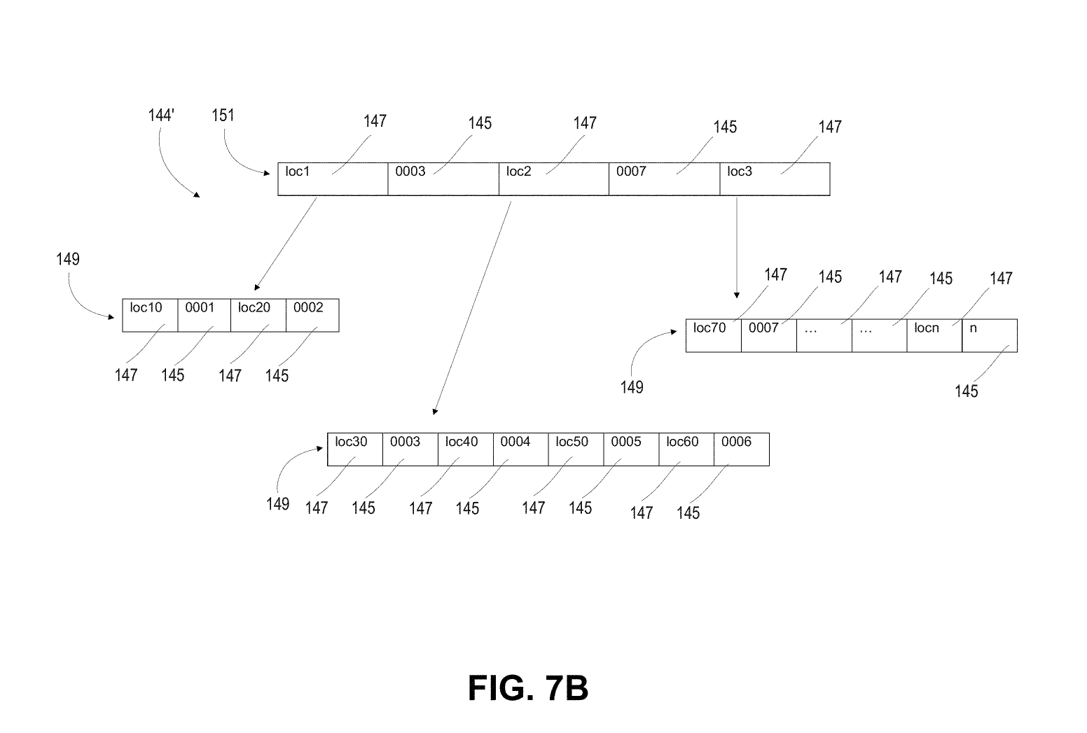

Database engine 122 may also maintain an index 144 for data in database 130, as depicted in FIG. 7A. Such indexing may improve performance of access requests. Indexing may be based on the expected workload of database system 100.

Indexing may be based on fields, e.g. columns of database tables. That is, each index may be for searching based on values in a key field (e.g. a particular column). Indexes may contain key values corresponding to a particular database field and may map the keys to locations of corresponding records in storage. For the sake of illustration, FIG. 7A depicts a simple sequential index 144. Entries in index 144 include a search key value 145, namely a value in the indexed column from a database record 132, and a pointer 147 to the record. Contents of index 144 may be searched, e.g., using a binary search algorithm, to identify records with the relevant search key values without individually scanning each record.

In other embodiments, the index may be a search tree, such as a binary tree or B-tree, for permitting a binary or similar search of values. For example, FIG. 7B depicts a representation of a B-tree index 144′. B-tree index 144′ includes leaf nodes 149 and one or more layers of non-leaf nodes 151. Each node contains a series of alternating search key values 145 and pointers 147. Pointers 147 of leaf nodes 149 point to records having the adjacent search key value 145. Pointers 147 of non-leaf nodes point to lower-layer nodes. Each pointer 147 in a non-leaf node 151 points to a node containing search key values 145 less than the search key value 145 following the pointer 147, if any, and equal to or greater than the search key value 145 preceding the pointer 147, if any.

Indexes may be clustered or non-clustered. In the case of a clustered index, the corresponding data records are stored in the order of the index. For example, as depicted in FIG. 5, records are stored in ascending order of values in ID column 134. Likewise, index 144 uses column 134 as a key field. That is, index 144 uses ID values from column 134 as a search key. In the case of a non-clustered index, the records are stored in an order different than that of the index.

As depicted in FIG. 7A, index 144 includes a value for each corresponding record of database 130. Alternatively, in other embodiments, records may be grouped, and index 144 may contain one entry for each group. In such embodiments, retrieving data may include searching for a relevant group, and then individually scanning the members of that group.

Typically, multiple indexes are stored for database 130. Each index may enable searching based on a particular column of database 130. For example, indexes may be created and maintained for each of ID column 134, date column 136, price column 138, customer_ID column 140 and Store_Location column 142. As will be apparent, no more than one index may be clustered. Additional indexes may be non-clustered.

Search performance may be fastest for clustered indexes. That is, if database 130 is stored as depicted in FIG. 5, searches based on an index of the ID column 134 may be faster than other columns, since data are stored in ID column order.

Database system 100 may store one or more replica copies of data in database 130 to protect against data loss, for example, due to failure of a hardware component. Referring again to FIG. 1, data store 104-1 of server 102-1 may store a primary copy of database 130. Data stores 104-2, 104-3 of servers 102-2, 102-3 may store first and second replica copies.

Replication manager 124 (FIG. 4) may be responsible for updating the replica copies of database 126 and maintaining consistency between the primary copy and the replica copies (generally referred to herein as replication).

In some embodiments, replication manager 124 may log changes at the primary copy of database 126 and propagate those changes to replica copies. Specifically, replication manager 124 monitors for changes in the primary (master) copy of database 130 at server 102-1 and, when changes occur, replication manager 124 produces and sends instructions to each of servers 102-2, 102-3 for replicating the changes in the replica copies. In such embodiments, the primary copy may be referred to as the master copy. Users may be permitted to make changes only in the master copy and conflicts between copies may therefore be avoided.

In other embodiments, users may be able to make changes on multiple copies of database 126. In such embodiments, each user-editable copy may be treated as a master copy. Therefore, such embodiments may be said to employ “multi-master” replication. In multi-master embodiments, replication manager 124 may include processes and algorithms for resolving conflicts between database copies, for example, if a record is edited concurrently in two different database copies. In an example, transactions may be performed in an ansychronous mode, according to which changes are initially made on a first copy, and updates are subsequently propagated to other copies. Transactions may not be considered complete, and records may be locked against further editing until all updates are completed. Other mechanisms for maintaining consistency are will be apparent to skilled persons.

Replica copies of database 126 may include copies of indexes maintained with the primary copy. Thus, queries may be performed on any copy of database 126 and accelerated using indexes so that queries may be performed on servers 102-2, 102-3 with substantially the same performance as server 102-1. Accordingly, in the event of a failure of one of servers 102, access requests may be directed to another server 102 with limited impact on performance.

As will be apparent, in some embodiments, Servers 102-1, 102-2 and 102-3 may be at different physical or geographical locations. For example, servers 102-1, 102-2, 102-3 may be in different buildings, cities or continents. Servers 102 may likewise be accessed by client computing devices in a number of different locations. Access scheduler 126 may receive incoming access requests from client computing devices 110 and direct the requests to one of servers 102. Requests may be directed based on, for example, physical proximity of the client computing device 110 to each server 102, the activity level of each server 102, or other factors.

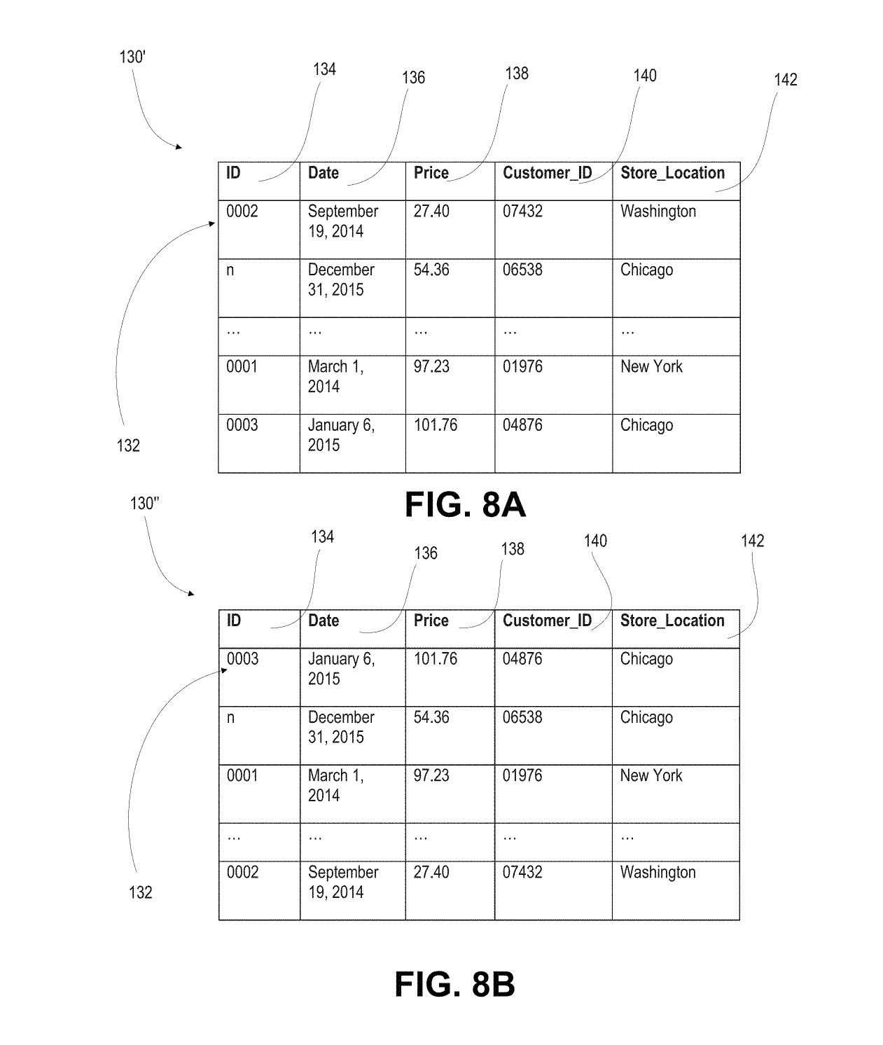

Ordering of data in the replica copies at servers 102-2, 102-3 may be controlled by replication manager 124. In example embodiments, replication manager 124 may order data in the replica copies differently than in the primary copy. For example, as noted above, the primary copy of database 130 stored at server 102-1 is ordered according to values in its ID column 134. The last record of database 130 has an ID value of n (hereinafter, referred to as the n^{th} record). As depicted in FIG. 8A, replica copy 130′ is stored in order of values of price column 138. The n^{th} record has the second-highest price and is therefore stored second, i.e. in the second storage location. As depicted in FIG. 8B, replica copy 130″ is stored in order of values of Store_Location column 142, and the n^{th} record is likewise stored second.

Indexes may be created and maintained for replica copies according to the ordering of records in those copies. For example, a clustered index of price column 138 may be created and maintained for replica copy 130′ and a clustered index of Store_Location column 142 may be created and maintained for replica copy 130″.

Though replica copies 130′, 130″ are ordered differently than the primary copy of database 130, the replica copies contain all of the data in database 130 and therefore protect against data loss due to failure of server 102-1 which hosts database 130. However, replica copies 130′, 130″ may be hosted at servers 102-2, 102-3 and used to perform searches. As compared to exact copies of database 130, re-ordered replicas 130′, 130″ may provide improved search performance.

Specifically, a database workload typically includes queries or selections formed using criteria on multiple different columns. For example, some searches may be based on an ID number, some searches may be based on a date, and some searches may be based on a combination thereof. Accordingly, in the absence of re-ordered replicas 130′, 130″, a workload may require additional non-clustered indexes to be maintained along with database 130. For example, to provide for efficient searching based on ID column 134, price column 138 and Store_Location 142, indexes of all three columns would be required along with database 130. If database 130 were to be backed up with exact copies, all of the indexes would typically be backed up as well.

Conversely, by backing up database 130 with re-ordered copies 130′, 130″, a single clustered index of the ID column 134 could be maintained with the primary copy of database 130, while the non-clustered indexes could be reduced or eliminated. A single clustered index of the price column 138 could be maintained with replica copy 130′ and a single clustered index of the Store_Location column 142 could be maintained with replica copy 130″.

As noted above, searching clustered indexes tends to be faster than searching non-clustered indexes. Accordingly, a workload including searches of each of the ID column 134, the price column 138 and the Store_Location 142 may be completed more quickly using the primary copy of database 130 in combination with replicas 130′, 130″, relative to using database primary copy alone with indexes of all three columns. Indeed, the workload may complete more quickly using database 130 and copies 130′, 130″ relative to three servers concurrently performing the search on identical copies of database 130.

In addition, replica copies 130′, 130″ may also have different non-clustered indexes, which may allow for index coverage of more columns, relative to a primary copy 130 and identical replicas. For instance, primary copy 130 may have a clustered index of ID column 134 and a non-clustered index of date column 136. Back-up copy 130′ may have a clustered index of price column 138 and a non-clustered index of customer_ID column 140, and back-up copy 130″ could have a clustered index of Store_Location column 142, without any non-clustered indexes. Thus, between primary copy 130, replica copy 130′ and replica copy 130″, indexes are provided for each of the columns depicted in FIG. 5, however, no more than two indexes (one clustered and one non-clustered) are required to be stored at any server 102.

Conversely, if database 130 were backed up with identical copies, in order to provide searchable indexes of all five columns, one clustered index and four non-clustered indexes would need to be provided with database 130. All five indexes would typically be backed up along with the database 130 itself. Thus, re-ordered replicas 130′, 130″ may allow for more columns to be indexed, and may reduce overall space taken by indexes, for the same number of columns.

Ordering and indexing of database 130 and replica copies 130′, 130″ may be controlled based on information in workload log 146. Specifically, replication manager 124 may be configured to choose ordering columns based on the performance impact of each column determined from workload log 146 (e.g., according to weighting values). Database 130 and replica copies 130′, 130″ may be ordered on the columns with the highest performance impact, and clustered indexes be created for those columns. Additional non-clustered indexes may be provided for other columns in accordance with their respective performance impact.

Alternatively, ordering columns may be explicitly chosen by a database administrator, for example, based on information in workload log 146, or based on historical or test data.

Replication manager 124 and access scheduler 126 may be configured to accommodate replica copies 130′, 130″ stored in orders different from primary copy 130 and with different indexes.

For example, access scheduler 126 maintains a record of ordering of primary copy 130 and replica copies 130′, 130″ and available indexes at each server 102. Access scheduler 126 may send a message comprising a query to database management system 117 at each other server 102, which may respond with a messages indicating the ordering of replica copies 130′, 130″. Such messages may be exchanged on startup of a server 102, at periodic time intervals, following a certain number of access requests, or according to any other suitable schedule.

When an access request is received, access scheduler 126 is configured to parse the request to determine selection criteria specified by the request and identify columns on which the selection criteria are based. Access scheduler 126 is further configured to compare the identified columns to the available indexes at each of servers 102-1, 102-2, 102-3. If the search criteria match a clustered index at one of the servers 102, access scheduler is configured to send the request to that server 102. For example, all searches based on price column 138 (FIG. 5) may be directed to server 102-2, which hosts replica copy 130′ and has a clustered index of the price column.

In other embodiments, access scheduler 126 may directly have access to ordering information of data at servers 102-1, 102-2 and 102-3, e.g. it may have access to a copy of each index. In such embodiments, access scheduler may simply retrieve the relevant records from server 102-2, rather than directing the received query to server 102-2 for execution. In one such example, access scheduler 126 may be part of a catalog node in a database using Apache™ Hadoop™ technology.

If the search criteria do not match any clustered index, the search may be sent to a server with a non-clustered index corresponding to the search criteria. Alternatively, if no server has any index corresponding to the search criteria, the request may be directed to the nearest or least busy server 102.

Replication manager 124 may be configured to propagate changes in database 130 to each of copies 130′, 130″. To do so, replication manager 124 is configured to optimize requests to create, update or delete requests. Received requests may be altered for better performance on replicas with particular indexes available. For example, in the SQL language, a received request may include an UPDATE statement which calls for data to be changed in records with certain criteria, e.g.:
UPDATE [table]
SET [data to be changed]
WHERE [selection criteria]

The request may, for example, specify data to be changed for all records with a particular ID number, e.g.:
UPDATE [table]
SET [data to be changed]
WHERE ID=0003

Such a statement could be efficiently carried out in primary copy 130. However, if the same instruction was passed to servers 102-2, 102-3 to be replicated in replica copies 130′, 130″, the resulting search would be less efficient, since replica copies 130′, 130″ do not have a clustered index for ID column 134 and may not have any index for ID column 134. In the absence of an index, carrying out the request may require scanning the value of ID column 134 in each record.

Accordingly, replication manager 124 may produce modified instructions which include selections based on indexed columns. For example, to propagate changes to server 102-2, which has a clustered index of Price column 138, replication manager 124 may determine price values from the selected records and pass instructions to server 102-2 with selection criteria based on those price values. For example, as depicted in FIG. 5, the record with ID=0003 has Price=101.76. Accordingly, replication manager 124 may construct a request as follows:
UPDATE [table]
SET [data to be changed]
WHERE PRICE=101.76 AND ID=0003

Since Price=101.76 may not uniquely identify a record, the original search criteria may also be included. As will be apparent, executing the above request may require a search of the Price column, and testing each of the returned records for ID=0003. Such instructions could be carried out relatively efficiently using the clustered index of price column 138 at server 102-2.

Similarly, to propagate the same update to replica copy 130″ at server 102-3, which has a clustered index of Store_Location column 142, replication manager 124 determine Store_Location values from the selected records and pass instructions to server 102-3 with selection criteria based on those Store_Location values. For example, as depicted in FIG. 5, the record with ID=0003 has Store_Location “Chicago”. Accordingly, replication manager 124 may construct a request as follows:
UPDATE [table]
SET [data to be changed]
WHERE Store_Location=“Chicago” AND ID=0003

Since Store_Location=“Chicago” may not uniquely identify a record, the original search criteria may also be included. As will be apparent, executing the above request may require a search of the Store_Location column, and testing each of the returned records for ID=0003. Such instructions may be carried out relatively efficiently using the Store_Location index at server 102-3.

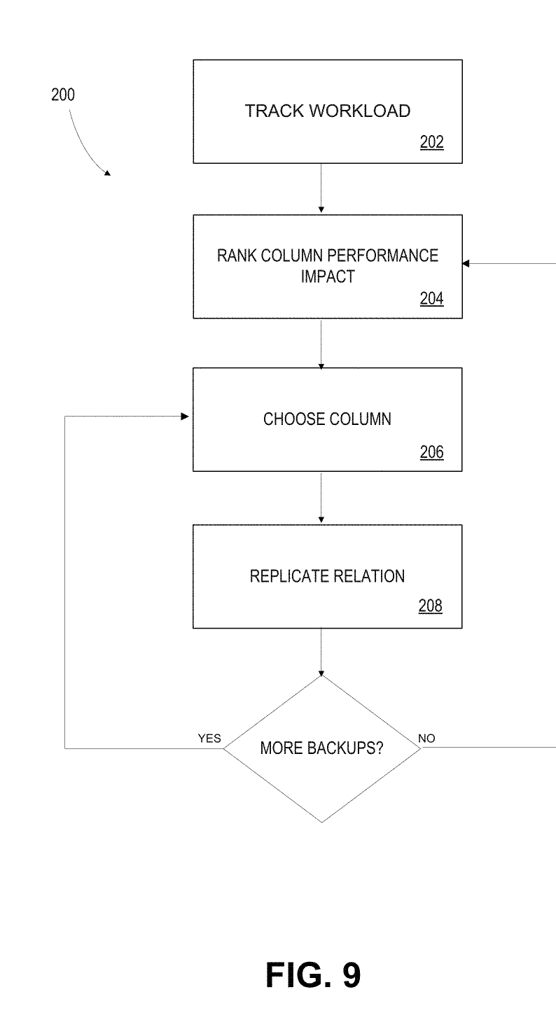

FIG. 9 depicts a flow chart of a process 200 performed by a server 102 under control of database management system 117 to create a replica copy of database 130.

At block 202, workload monitor 128 monitors access requests received by server 102 and maintains a record of the requests in workload log 146. Each time a request requires searching of a column, workload monitor 128 increments a count in a corresponding row of workload log 146. Workload monitor 128 may track the search time, namely, the time elapsed between receipt of the access request and returning of the result, and search period, namely the time elapsed between successive searches on each column. In addition, workload monitor may track the average search time and search period.

At block 204, workload monitor 128 may rank the columns according to their impact on search performance. The impact of a particular column may be a function of the product of the search time and the frequency of searches on the column.

At block 206, replication manager 124 chooses a column identified as having high performance impact. The chosen column may be the column with the highest performance impact. Alternatively, if the column with the highest performance impact is the column on which the primary copy is ordered, the chosen column may be that with the next-highest performance impact.

At block 208, replication manager 124 replicates the database 130 at a server 102. If there are more replicas to be made, the process returns to block 206, and the column with the next-highest performance impact is chosen. If no further replicas are to be made, the process returns to block 204, and workload monitor 128 periodically or continuously tracks the workload of database 100 and the performance impact of each column. If there is a change in the columns with the highest performance impact, replication manager 124 may direct one or more replicas to be re-ordered based on a new column.

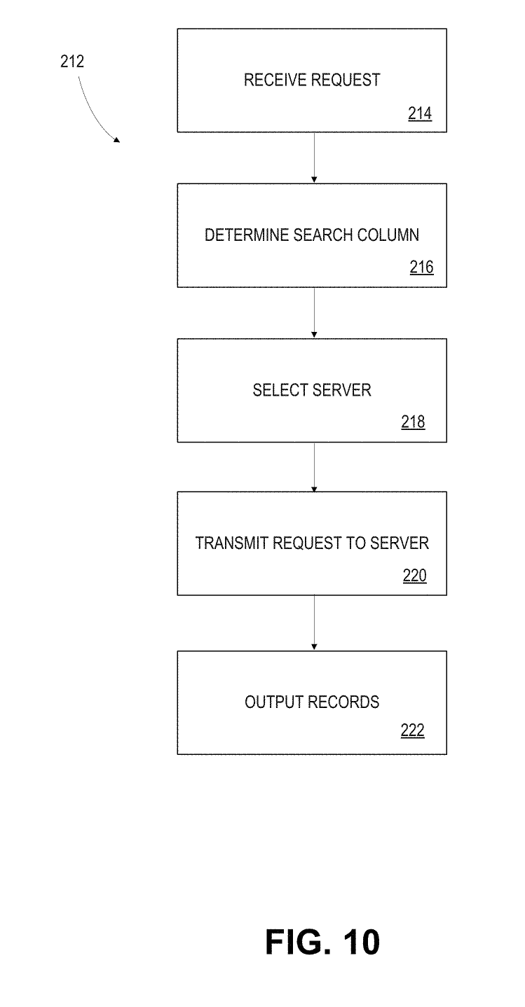

FIG. 10 depicts a flow chart of a process 212 of accessing data from database system 100. At block 214, a request to access database 130 is received at one of servers 102. The access request may be, for example, a query.

At block 216, access scheduler 126 parses the access request to identify the column or columns that need to be searched to perform the access request. Access scheduler 126 may, for example user, regular expression matching or other suitable algorithms to identify search operators in the access request and to identify columns to be searched.

At block 218, access scheduler 126 compares the columns to be searched to the available clustered indexes associated with database 130 and each of its replica copies. If a clustered index exists for one of the key fields (e.g. columns) to be searched, access scheduler 126 selects the server with the relevant replica copy and index and, at block 220, sends a message to that server containing the access request.

In some embodiments, the request may require searching on multiple columns of database 130 which have clustered indexes in servers 102. In such cases, access scheduler 126 may send the access request to the closest server 102 with a relevant clustered index.

The access request is executed at the selected server. Specifically, database engine 121 searches the index for the record or records requested. The index points to the storage location or range of locations containing the relevant records.

At block 222, the request result is loaded and returned to the client computing device 110. An electronic message containing the query result may be sent directly from the server 102 performing the query to the client computing device 110 over networks 106, 112. In some embodiments, the client computing device 110 may be in communication with a different server 102 from the one performing the search. In such embodiments, an electronic message containing the request result may be sent to the client computing device 110 by way of another server 102.

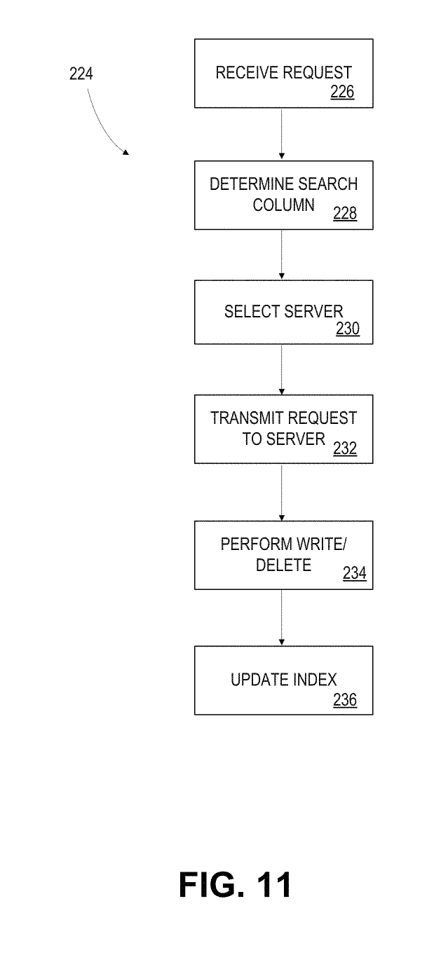

FIG. 11 depicts a process 224 of adding, deleting or updating data in database system 100. At block 226, a server 102 receives a request from a client computing device 110. The request may include an INSERT, DELETE or UPDATE request.

The request may include selection criteria based on values of one or more columns. For example, a request may instruct database system 100 to delete all records with value “Washington” in Store_Location column 142. Alternatively, the request may instruct database system 100 to add one or more new records with value “Toronto” in Store_Location column 142. As will be apparent, fulfilling such requests may involve searching one or more column indexes to determine the correct storage location or range of locations in which data should be inserted, deleted or changed, while maintaining the order of data.

At block 228, access scheduler 126 parses the access request to identify the column or columns that need to be searched to perform the access request. Access scheduler 126 may, for example, use regular expression matching or other suitable algorithms to identify search operators in the access request and to identify columns to be searched.

At block 230, access scheduler 126 compares the columns to be searched to the available clustered indexes associated with database 130 and each of its replica copies. If a clustered index exists for one of the columns to be searched, access scheduler 126 selects the server 102 with the relevant replica copy and index and, at block 232, sends a message to that server 102 containing the access request. The server 102 searches the index to determine the appropriate storage location for writing or deleting and performs the necessary write or deletion. In some embodiments, the scheme for maintaining consistency between database 130 and its replicas may require that updates to database 130 and its replicas are performed concurrently. In such embodiments, requests may be sent simultaneously to database 130 and all replicas, rather than selecting an optimal database or replica in which to initially commit the change.

At block 236, after the insertion, deletion or update of data, replication manager 124 of the server 102 that performed the read or write updates the clustered index and non-clustered indexes that are present.

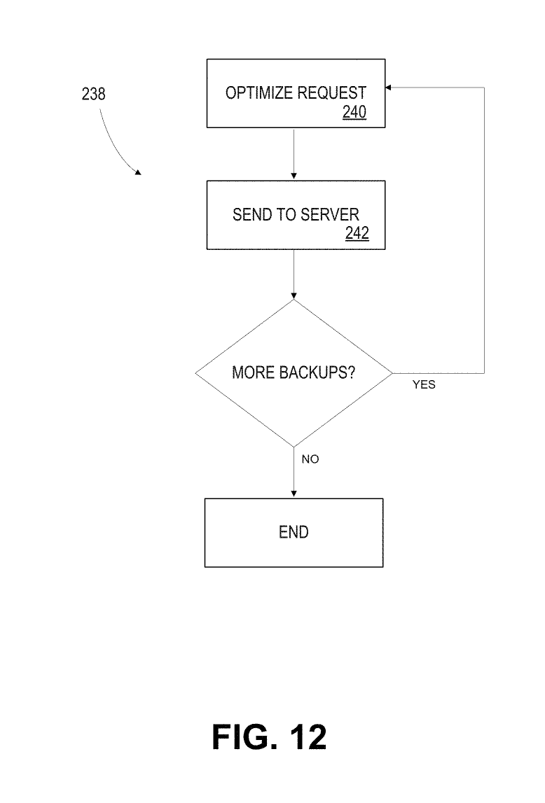

Replication manager then sends one or more messages for causing updating of replica copies 130′, 130″. A process 238 for updating replicas is depicted in FIG. 12.

At block 240, replication manager 124 compares the search criteria of the requested INSERT, DELETE or UPDATE operation to the available search indexes at the replicas. The request may be optimized for running at the server 102 hosting the replica. In particular, the request may be altered so that it identifies records to be updated, deleted or inserted based on values of columns that are indexed in the replica. For example, if the initial request is to update prices associated with all records having value “Chicago” in Store_Location column 142, and the replica has an index of values in ID column 134, the request may be modified as described above to select records with “Chicago” in Store_Location column 142 based on their corresponding values in ID column 134.

At block 242, the optimized request is sent to the replica server 242. If more replicas need to be updated, the process returns to block 240, and the original request is optimized for the next replica. Alternatively, if no further replicas need to be updated, the process ends.

As described above, database system 100 includes a database 130 and two replica copies 130′, 130″. In other embodiments, more or fewer replica copies may be provided. In addition, a database system may include both exact replicas and re-ordered replicas of a database. For example, a system could comprise a master database, one or more re-ordered replicas, and one or more identical replicas stored in the same order and having the same indexes as the master.

In some embodiments, the systems and methods disclosed herein may be used in a distributed database, wherein primary copy of database 130 is stored in parts spread among data stores at a plurality of servers. In such embodiments, replica copies 130′, 130″ may likewise be stored in parts.

In some embodiments, a user may manually select columns on which primary copy of database 130 and replica copies 130′, 130″ are ordered. The user may review the contents of workload log 146 to do so.

As described above, database 130 is a relational database including one or more tables, Records of database 130 (e.g. rows of the database tables) are ordered according to corresponding values in columns of the database tables. In other embodiments, the systems and methods described herein may be used in the context of other types of databases, such as document or object-oriented databases.

For example, in document-oriented databases, records may take the form of documents. The documents may contain fields of data, some of which may be common to the documents, Documents may be ordered according to values of certain fields. Replica database copies may have documents ordered according to values of fields different than those on which the primary copy is ordered. Alternatively, the primary copy may be randomly ordered, and replica copies may be ordered based on desired fields.

In object-oriented databases, records may take the form of object instances. The object instances may contain fields of data, some of which may be common, Object instances may be ordered according to values of certain fields. Replica database copies may have object instances ordered according to values of fields different than those on which the primary copy is ordered. Alternatively, the primary copy may be randomly ordered, and replica copies may be ordered based on desired fields.

In some embodiments, database 130 or its replica copies 130′, 130″ may be randomly ordered or only semi-ordered on a particular key column.

In some embodiments, database 130 or its replica copies 130′, 130″ may be ordered based on combined values of a plurality of columns, rather than a single column. For example, records may be ordered based on the sum of values in a plurality of fields, concatenated values of multiple fields, hash values generated from a plurality of fields, or the like.

As described above, database 130 and its replica copies 130′, 130″ are ordered differently. Alternatively or additionally, in some embodiments, other properties of replica copies 130′, 130″ may differ from those of database 130. For example, data stored in one or more of database 130 and replica copies 130′, 130″ may be compressed. Compression may be done using different algorithms for different copies. For example, replica copy 130′ may be compressed using an algorithm optimized for storage efficiency, and replica copy 130″ may be compressed using an algorithm optimized for speed or efficiency of decompression, or may not be compressed at all. In such embodiments, some access requests may be carried out using replica copy 130′ to limit bandwidth consumption and some access requests may be carried out using 130″ to limit computational load or decompression time.

In some embodiments, database 130 and replica copies 130′, 130″ may be stored in different database formats, different file formats or different data formats. In such embodiments, access requests may be carried out based on the client from which they are received. For example, an access request may be received from a client which has native support for only a particular database or file format. Such a request may be carried out using a replica copy with a matching format, in order to avoid format conversion.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps

As can be understood, the examples described above and illustrated are intended to be exemplary only. The invention is defined by the appended claims.

What is claimed is:

1. A database system comprising:
a first server;
a first data store at said first server containing a primary copy of a database comprising records including at least first and second key fields, said records stored in a first order;
a replica data store, containing a replica copy of said database, with said records ordered stored in a second order different from said first order, said second order according to values of said second key field;
said first server configured to receive a request to access said records, and configured to access said records from said replica copy if said request includes a criterion based on values of said second key field.

2. The database system of claim 1, wherein said first order is based on values of said first key field.

3. The database system of claim 2, wherein said first data store contains a search index comprising values in said first key field and said second data store contains a search index comprising values in said second key field.

4. The database system of claim 1, further comprising a second server, said replica data store interconnected with said second server.

5. The database system of claim 4, further comprising a third server and a second replica data store, said second replica data store containing a second replica copy of said database, with said records ordered according to values of a third key field, different from said first and second key fields, wherein said first server is configured to direct said request to said third server if said request includes a criterion based on values of said third key field.

6. The database system of claim 5, wherein said first, second and third servers are in communication over a network.

7. The database system of claim 4, wherein said second server is configured to receive a request to access said database records, and to direct said request to said first server if said request includes a criterion based on values of said first key field.

8. The database system of claim 4, wherein said first server is configured to replicate changes to said database in said replica copy, by modifying a request to change said database to create a modified request, and forwarding said modified request to said second server.

9. The database system of claim 8, wherein said modifying a request comprises executing a received request on a selected database record at said first data store and constructing a modified request based on a value of said second key field in said selected database record.

10. The database system of claim 1, wherein said first server is configured to select said second key field based on a set of received requests to access said database records.

11. The database system of claim 10, wherein said first server is configured to maintain a log of a set of received requests to access said database records and performance data associated with said set of received requests, and select said second key field based on said log.

12. The database system of claim 11, wherein said log comprises, for each field in said database, a count of requests comprising a criterion in that field, and performance measurements associated with said requests.

13. The database system of claim 1, wherein said second order is based on values of a plurality of fields, including said second key field.

14. The database system of claim 4, wherein said second server is physically separate from said first server.

15. The database system of claim 4, wherein said first and second servers are server instances on a single machine.

16. A method of backing up database records ordered in a first order, comprising:
selecting a key field ;
copying said database records to a data store to create a replica copy; and
ordering said database records of said replica copy in a second order, different from said first order and according to values of said key field.

17. The method of claim 16, wherein said key field is a second key field and said first order is based on values of a first key field.

18. The method of claim 16, comprising creating a search index comprising said values of said key field.

19. The method of claim 16, wherein said copying said database records comprises sending said database records from a first server to a second server.

20. The method of claim 17, comprising selecting a third key field different from said first and second key fields;
copying said database records to a second data store to create a second replica copy;
ordering said database records of said second replica copy according to values of said third key field;
creating a search index comprising said values of said third key field.

21. The method of claim 20, wherein said copying said database records comprises sending said database records to a server across a computer network.

22. The method of claim 16, further comprising receiving a request to access said database records, determining that said request includes a criterion based on values of said key field, and accessing said database records using said replica copy.

23. The method of claim 16, further comprising, in response to receiving a request to change at least one database records, modifying said request to include a selection of said at least one database record based on a value of said key field, and sending said modified request to a server for propagating said change to said replica copy.

24. The method of claim 16, further comprising maintaining a log of requests to access said database records and performance data associated with said requests, and selecting said key field based on said log.

25. The method of claim 24, wherein said maintaining a log comprises, for each field of said database records maintaining a count of requests comprising a criterion in that field, and performance measurements associated with said requests.

26. A method of accessing database records on a database system comprising a primary database copy and at least one replica database copy, records of said replica copy ordered differently than records of said primary copy and based on values of a database field, comprising:
receiving a request to access said database records, said request comprising a selection criterion based on a value of a queried database field;
selecting one of said primary copy and said replica copy, said selected one of said primary copy and said replica copy ordered based on said queried database field;
returning database records by searching an index of said queried database field at the selected one of said primary copy and said replica copy.

27. The method of claim 26, wherein said request comprises instructions to change at least one modified database record, the method further sending update instructions to the other of said primary copy and said replica copy, said update instructions comprising a modified criterion identifying the modified database record based on a value of a second database field, different from said queried database field.
